(19) United States
(12) Patent Application Publication
(10) Pub. No.: US 2017/0109778 A1
(43) Pub. Date: Apr. 20, 2017

(54) METHOD FOR PROVIDING ADDITIONAL SERVICE USING LOCK SCREEN MODE, AND SYSTEM AND APPARATUS FOR THE SAME

(71) Applicant: SK PLANET CO., LTD., Gyeonggi-do (KR)

(72) Inventor: Jongsoo LEE, Seoul (KR)

(73) Assignee: SK PLANET CO., LTD., Gyeonggi-do (KR)

(21) Appl. No.: 15/128,029

(22) PCT Filed: Jan. 22, 2015
(86) PCT No.: PCT/KR2015/000656

§ 371 Date: Sep. 21, 2016

(30) Foreign Application Priority Data
Mar. 21, 2014 (KR) 10-2014-0033119
Mar. 21, 2014 (KR) 10-2014-0033120

(51) Int. Cl. G06Q 30/02; G06Q 20/32; G06Q 20/36

(52) U.S. Cl. CPC G06Q 30/0239; G06Q 20/367; G06Q 20/322; G06Q 30/0267

(57) ABSTRACT

The present invention relates to a method for providing an additional service using a screen lock mode and a system and apparatus for the same. Especially, the present invention displays additional information, which is provided through a wallet service in a screen lock state of a standby mode, on one side of the screen, and provides the additional information by automatically executing a wallet application in response to cancellation of a screen lock function or provides, through an unlock screen, mission execution information that requires user participation. Further, when there is a request for mission execution through the unlock screen, the present invention provides a mission execution screen for execution of a mission by activating an electronic wallet, and then provides an additional service according to a result of the execution of the mission.

### TECHNICAL FIELD

The present invention relates to a method for providing an additional service using a screen lock mode and a system and apparatus for the same, and more particularly, to a method for providing an additional service using a screen lock mode, which may display additional information which is provided through a wallet service in a screen lock state of a standby mode, on one side of a screen, provide the additional information by automatically executing a wallet application in response to cancellation of a screen lock function or provide, through an unlock screen, mission execution information that requires user participation, provide a mission execution screen for execution of a mission by activating an electronic wallet when there is a request for mission execution through the unlock screen, and then provide an additional service according to a result of the execution of the mission, and a system and apparatus for the same.

### BACKGROUND ART

With the development of mobile communication networks and terminal specifications, mobile communication terminals have become essential belongings of modern people that penetrate boundaries of conventional simple communication devices or information providing devices and are showing a trend of evolving into total entertainment devices.

In particular, with the rapid spread of smart phones, a mobile phone has been situated as a new business model that provides a variety of additional services as well as simple telephone functions. Unlike a conventional portable phone (feature phone), such a smart phone has advantages capable of additionally installing a variety of applications (app) required by a user and freely using wireless Internet.

However, since only images or text phrases set by a user may be displayed on a screen-lock screen of the conventional smart phone and an unlock screen may be provided for guiding an unlock method or receiving a lock pattern, only predetermined texts or images set by a user may be output through such an unlock screen.

### DISCLOSURE

### Technical Problem

The present invention is directed to providing a method for providing an additional service using a screen lock mode, which may display additional information which is provided through a wallet service in a screen lock state of a standby mode, on one side of the screen and provide the additional information by automatically executing a wallet application in response to cancellation of a screen lock function, and a system and apparatus for the same, so that inconvenience may be improved in which only an image or text phrase set by a user is displayed while failing to provide information about an application installed on a screen-lock screen of a conventional smart phone.

The present invention is also directed to providing a method for providing an additional service using a screen lock mode, which may provide the additional service using an unlock screen on which only texts or images are simply output, and particularly provide, through the unlock screen, mission execution information that requires user participation, provide a mission execution screen for execution of a mission by activating an electronic wallet when there is a request for mission execution through the unlock screen, and then provide an additional service according to a result of the execution of the mission, and a system and apparatus for the same.

### Technical Solution

One aspect of the present invention provides a service device including: a service communication unit that transmits and receives data associated with provision of additional information through a control of a screen lock function of one or more terminals; and a service control unit that collects the additional information associated with a wallet service, transmits the collected additional information to the one or more terminals through a wallet application, determines detailed information about the additional information requested through the wallet application from the terminal according to cancellation of the screen lock function of the terminal, and controls the determined detailed information to be provided to the corresponding terminal.

Here, the service device may further include a service storage unit that stores additional information including detailed information of at least one of recommended card information, advertising information, discount information, and coupon information which are provided through the wallet service.

Also, the service control unit may set a recommended time zone with respect to the terminal, and then transmit at least one of recommended card information, advertising information, discount information, and coupon information to the terminal when the recommended time zone comes.

Also, the service control unit may determine a frequency of use of a coupon or a discount card among membership services with respect to the terminal, extract an item existing in the same category as the coupon or the discount card, and transmit the extracted item to the terminal.

Also, the service control unit may set mission execution information that requires user participation, which is to be provided through an unlock screen of the terminal, provide the mission execution information to the terminal in response to a request from the terminal, provide a mission execution screen for executing a mission by activating an electronic wallet provided in the terminal when there is a request for execution of the mission through the unlock screen of the terminal, and provide an additional service set in advance according to whether the execution of the mission is completed.

Also, the service control unit may collect user information of the terminal, compare the collected user information with a service providing condition set in advance to select a game, provide the selected game through the unlock screen, and provide the mission execution screen when the game is completed.

Also, the service control unit may guide a result of the provision of the additional service to the terminal through a text message service.

Also, the service control unit may collect advertising condition information that defines one or more advertising contents and an environment to which the advertising contents are to be output, and output the corresponding advertising contents through the mission execution screen of the terminal selected according to the collected advertising condition information.

Also, the advertising condition information may be set by combining at least one of user's location, age, occupation, and sex.

Another aspect of the present invention provides a terminal including: a communication unit that communicates with a service device to transmit and receive data associated with provision of additional information through a control of a screen lock function; and a control unit that receives the additional information through a wallet application from the service device, extracts image information corresponding to the received additional information, outputs the extracted image information on one side of a screen when the screen lock function is set in a standby mode, and controls to provide the additional information associated with the image information by executing the wallet application when the screen lock function is cancelled.

Here, the control unit may recognize at least one piece of security information of drag, pattern recognition, face recognition, voice recognition, fingerprint recognition, biometric recognition, a password, and a PIN (personal identification number) in order to cancel the screen lock function.

Also, the terminal may further include a storage unit that stores location information of a corresponding store capable of using at least one piece of additional information of recommended card information, advertising information, discount information, and coupon information, wherein the control unit may determine current location information, and output the additional information on the screen when the determined current location information is matched with the stored location information.

Also, the control unit may receive an item existing in the same category as a coupon or a discount card among membership services from the service device, classify and store the received item into location information or a time zone each corresponding to the received item, determine current location information or a current time zone, and output the additional information on the screen when the determined current location information or time zone is matched with the stored location information or time zone.

Also, the control unit may receive the additional information applicable to a recommended time zone from the service device to store the received additional information, determine whether a specific time zone is matched with the recommended time zone when the specific time zone comes, and output the additional information on the screen according to whether to have the additional information corresponding to the time zone when the specific time zone is matched with the recommended time zone.

Also, the control unit may provide mission execution information that requires user participation through an unlock screen when outputting the unlock screen, provide a mission execution screen for executing a mission by activating an electronic wallet when there is a request for execution of the mission through the unlock screen, and then request an additional service set to correspond to the mission from the service device when the execution of the mission is completed on the mission execution screen.

Also, the control unit may receive a result of the request for the additional service through a text message service.

Also, the control unit may include a screen lock processing module that outputs the unlock screen at the time of a screen lock setting, and outputs the mission execution information through the unlock screen while switching the unlock screen to a standby screen of the terminal, when an unlock pattern set in advance is input, and an electronic wallet module that is activated to provide the mission execution screen when mission execution is requested on the unlock screen, and requests an additional service set to correspond to a corresponding mission from the service device according to a result of the mission execution.

Also, the electronic wallet module may provide a game set in advance through the unlock screen before providing the mission execution screen, and provide the mission execution screen when the game is completed.

Also, the electronic wallet module may collect user information of the terminal, compare the collected user information with a service providing condition set in advance, and provide the game according to a result of the comparison.

Also, the control unit may output advertising contents set in advance through the mission execution screen.

Still another aspect of the present invention provides a system for providing an additional service using a screen lock mode, including: a terminal that receives additional information through a wallet application from a service device, extracts image information corresponding to the received additional information, outputs the extracted image information on one side of a screen when a screen lock function is set in a standby mode, and provides the additional information associated with the image information by executing the wallet application when the screen lock function is cancelled; and a service device that collects the additional information associated with a wallet service, transmits the collected additional information to the terminal through the wallet application, determines detailed information about the additional information requested through the wallet application according to cancellation of the screen lock function of the terminal, and provides the determined detailed information to the terminal.

Yet another aspect of the present invention provides a method for providing an additional service using a screen lock mode, including: collecting, by a service device, additional information associated with a wallet service; transmitting, by the service device, the collected additional information to one or more terminals through a wallet application; determining, by the service device, detailed information about the additional information requested through the wallet application according to cancellation of a screen lock function of the terminal; and providing, by the service device, the determined detailed information to the corresponding terminal.

Here, the transmitting may include matching, by the service device, the additional information collected from payment service companies and service providing companies with image information corresponding to the additional information to transmit the matched information to the one or more terminals in real time.

Also, the determining may include determining, by the service device, the additional information including the detailed information of at least one of recommended card information, advertising information, discount information, and coupon information.

Also, the providing may include setting, by the service device, a recommended time zone with respect to a specific terminal, and transmitting, by the service device, at least one of recommended card information, advertising information, discount information, and coupon information to the corresponding terminal when the set time zone comes.

Also, after the providing, the method may further include: determining, by the service device, a frequency of use of a coupon or a discount card among membership services with respect to the one or more terminals; extracting, by the service device, an item existing in the same category as the coupon or the discount card; and transmitting, by the service device, the extracted item to the terminal.

Further aspect of the present invention provides a method for providing an additional service using a screen lock mode, including: receiving, by a terminal, additional information from a service device through a wallet application; extracting, by the terminal, image information corresponding to the received additional information; outputting, by the terminal, the extracted image information on one side of a screen when a screen lock function is set in a standby mode; and providing, by the terminal, the additional information associated with the image information by executing the wallet application when the screen lock function is cancelled.

Here, the receiving may include temporarily storing, by the terminal, the additional information received from the service device.

Also, the outputting may include determining, by the terminal, whether the screen lock function for activation of the standby mode is set.

Also, the additional information may include detailed information of at least one of recommended card information, advertising information, discount information, and coupon information which are associated with a payment service or a membership service.

Also, the extracting may include extracting, by the terminal, the image information including at least one of an icon, a discount rate image, and a coupon image which represent the additional information.

Also, the providing may include detecting, by the terminal, a signal for selecting a display area of the image information output in the standby mode, and automatically executing, by the terminal, the wallet application according to a setting for canceling the input screen lock function, after the terminal selects the display area.

Also, the providing may further include limiting, by the terminal, provision of the additional information when the terminal cancels the screen lock function without selecting a display area of the image information output in the standby mode.

Also, after the providing, the method may further include: storing, by the terminal, location information of a corresponding store associated with at least one of recommended card information, advertising information, discount information, and coupon information; and determining, by the terminal, current location information and outputting, by the terminal, the at least one of recommended card information, advertising information, discount information, and coupon information on the screen when the determined current location information is matched with the stored location information.

Also, after the providing, the method may further include: receiving, by the terminal, an item existing in the same category as a coupon or a discount card among membership services from the service device; classifying and storing, by the terminal, the received item into location information or a time zone each corresponding to the received item; and determining, by the terminal, current location information or a current time zone and outputting, by the terminal, at least one of recommended card information, advertising information, discount information, and coupon information when the determined current location information or time zone is matched with the stored location information or time zone.

Also, after the providing, the method may further include: receiving, by the terminal, the additional information about at least one of recommended card information, advertising information, discount information, and coupon information which are applicable to a recommended time zone from the service device; storing, by the terminal, the received additional information; determining, by the terminal, whether a specific time zone is matched with the recommended time zone when the specific time zone comes; determining, by the terminal, whether to have the additional information corresponding to the time zone when the specific time zone is matched with the recommended time zone; and outputting, by the terminal, the additional information according to whether to have the additional information.

Further aspect of the present invention provides a method for providing an additional service using a screen lock mode, including: providing, by a terminal in which the screen lock mode is set, mission execution information that requires user partition through an unlock screen when outputting the unlock screen; providing, by the terminal, a mission execution screen for executing a mission by activating an electronic wallet when there is a request for execution of the mission through the unlock screen; and requesting, by the terminal, the additional service set to correspond to the mission from a service device when the execution of the mission is completed on the mission execution screen.

Here, the providing of the mission execution information may include providing a game set in advance through the unlock screen, and providing the mission execution screen when the game is completed.

Also, the mission execution screen may be a screen for executing at least one of issue of an additional service card of an affiliate associated with an electronic wallet service and issue of a coupon thereof.

Also, the providing of the mission execution screen may include outputting advertising contents targeted to a user through the mission execution screen.

Also, the additional service may include at least one of point payment and coupon issue.

Also, the method may further include receiving a result of the provision of the additional service through a text message service in response to the request for the additional service.

Also, the providing of the mission execution information may further include collecting user information of the terminal and comparing the collected user information with a service providing condition set in advance to select the game.

Also, the providing of the mission execution information may further include receiving information about the game from the service device.

Also, the service providing condition may be set in consideration of at least one of whether an additional service card of an affiliate of an electronic wallet service is issued, whether the additional service card is used, and a period of time during which the additional service card is used.

Further aspect of the present invention provides a method for providing an additional service using a screen lock mode, including: setting, by a service device that provides the additional service using the screen lock mode, mission execution information that requires user participation through an unlock screen of a terminal; providing, by the service device, the mission execution information to the terminal in response to a request from the terminal; providing, by the service device, a mission execution screen for executing a mission by activating an electronic wallet provided in the terminal, when there is a request for execution of the mission through the unlock screen of the terminal; and providing, by the service device, the additional service set to correspond to the mission in conjunction with the electronic wallet, when completion of the execution of the mission is reported from the terminal.

Here, the providing of the mission execution information may include collecting user information of the terminal and comparing the collected user information with a service providing condition set in advance to select a game, and providing the selected game through the unlock screen and activating the electronic wallet when the game is completed.

Also, the method may further include providing a result of the provision of the additional service to the terminal through a text message service.

Also, the method may further include collecting advertising condition information that defines one or more advertising contents and an environment to which the advertising contents are to be output; collecting user information associated with a user of one or more terminals; and comparing the user information with the advertising condition information and setting the terminal to which each of the advertising contents is to be provided, wherein the advertising contents may be provided through the mission execution screen of the set terminal.

Further aspect of the present invention provides a computer-readable recording medium that records a program for executing the method for providing the additional service using the screen lock mode.

### Advantageous Effect

According to the present invention, information about an installed application other than images or text phrases set by a user may be provided in advance on a screen-lock screen of a terminal, thereby helping user convenience.

In addition, payment card or coupon information may be provided on the screen-lock screen, thereby increasing a use opportunity of a wallet application.

In addition, the payment card or the coupon information provided on the screen-lock screen may be targeted and provided depending on ages of users, thereby enabling efficient marketing.

In addition, when a lock mode of a terminal is cancelled, mission execution information that requires user participation may be provided through an unlock screen, and when there is a request for mission execution through the unlock screen, a mission execution screen for execution of a mission may be provided by activating an electronic wallet, and then an additional service may be provided according to a result of the execution of the mission. In particular, when a predetermined game is completed by providing the game through the unlock screen, the additional service may be provided through the mission execution screen.

Accordingly, the present invention may provide, through the unlock screen which a user always uses, a mission associated with the issue and use of an additional service card using the electronic wallet, and provide an additional service such as point payment or coupon issue according to a result of the execution of the mission, thereby increasing the utilization rate of the electronic wallet.

### DESCRIPTION OF DRAWINGS

FIG. 1 is a view showing constituent components of a system for providing additional information through a control of a screen lock function according to an embodiment of the present invention;

FIG. 2 is a block diagram showing constituent components of a terminal according to the present invention;

FIG. 3 is a block diagram showing constituent components of a service device according to the present invention;

FIG. 4 is a flowchart for describing an operation method of a terminal according to an embodiment of the present invention;

FIG. 5 is a flowchart for describing an operation method of a service device according to an embodiment of the present invention;

FIGS. 6A to 6C are exemplary views for describing a process of providing additional information through a control of a screen lock function according to an embodiment of the present invention;

FIGS. 7 and 8 are flowcharts showing a method for providing an additional service using a screen lock mode executed by a terminal according to an embodiment of the present invention;

FIG. 9 is a flowchart showing a method for providing an additional service using a screen lock mode executed by a service device according to an embodiment of the present invention;

FIG. 10 is a flowchart showing a method for providing an additional service using a screen lock mode executed by a service device according to another embodiment of the present invention; and

FIG. 11 is an exemplary view of an unlock screen provided according to the present invention.

### MODES OF THE INVENTION

Hereinafter, preferred embodiments according to the present invention will be described with reference to the accompanying drawings. However, in the following description and the accompanying drawings, detailed description of well-known functions and structures incorporated herein may be omitted to avoid obscuring the subject matter of the present invention. In addition, it should be noted that the same reference numerals throughout the specification refer to like elements.

Terms and words used in the detailed description and the claims should not be construed as a typical or dictionary meaning, but should be interpreted as the meaning and concept conforming to the technical idea of the present invention based on the principle that the inventor can properly define the concept of the terms to explain his or her invention in the best way. Therefore, configurations shown in embodiments and the drawings of the present invention rather are examples of the most preferable exemplary embodiment and do not represent all of the technical spirit of the invention. Thus, it will be understood that various equivalents and modifications that replace the configurations are possible when filing the present application.

Hereinafter, as a representative example of a terminal according to an embodiment of the present invention, a mobile communication terminal that is connected to a communication network to provide a wallet service using online will be described, but the terminal is not limited to the mobile communication terminal and may be applicable to a variety of terminals such as all information communication devices, multimedia terminals, wired terminals, fixed terminals, IP (Internet protocol) terminals, and the like. In addition, the terminal may be advantageously utilized when it is a mobile terminal having a variety of mobile communication specifications such as a portable phone, a PMP (portable multimedia player), an MID (mobile Internet device), a smart phone, a desktop, a tablet PC, a note books, a Net book, an information communication device, or the like.

Hereinafter, a system for providing additional information through a control of a screen lock function according to an embodiment of the present invention will be described.

FIG. 1 is a view showing constituent components of a system for providing additional information through a control of a screen lock function according to an embodiment of the present invention.

Referring to FIG. 1, a system 100 for providing additional information through a control of a screen lock function according to an embodiment of the present invention includes a terminal 10, a service device 20, and a communication network 30.

The terminal 10 according to the present invention or a processor mounted on the service device 20 may process a program instruction for executing a method according to the present invention. According to one implementation example, the processor may be a single-threaded processor, or according to another implementation example, the processor may be a multi-threaded processor. Further, the processor can process an instruction stored on a memory or a storage device.

The communication network 30 performs a series of data transmission and reception operations for data transmission and information exchange between the terminal 10 and the service device 20. In particular, as the communication network 30, various types of communication networks may be used, and for example, wireless communication methods such as WLAN (wireless LAN), Wi-Fi, Wibro, Wimax, HSDPA (high speed downlink packet access), etc., may be used, and wired communication methods such as Ethernet, xDSL (ADSL, VDSL), HFC (hybrid fiber coax), FTTC (fiber to the curb), FTTH (fiber to the home), etc., may be used. Meanwhile, the communication network 30 is not limited to the above-mentioned communication methods, and may include all types of communication methods which are well-known or will be developed in the future in addition to the above-mentioned communication methods.

The terminal 10 is connected to the service device 20 via the communication network 30 to transmit and receive all kinds of data for a wallet service. In particular, the terminal 10 according to the present invention receives additional information from the service device 20 through a wallet application. For example, the additional information includes detailed information of at least one of recommended card information associated with a payment service or a membership service, advertising information, discount information, and coupon information. Next, the terminal 10 extracts image information corresponding to the received additional information. Here, the image information includes at least one of an icon, a discount rate image, and a coupon image which represent additional information.

The terminal 10 outputs the received image information to a screen of a standby mode when a screen lock function is set in the standby mode. Here, when the screen lock function is cancelled, the terminal 10 executes the wallet application and provides additional information related to the image information. At this point, the terminal 10 may recognize at least one piece of security information of drag, pattern recognition, face recognition, voice recognition, fingerprint recognition, biometric recognition, a password, and a PIN (personal identification number) in order to cancel the screen lock function.

The terminal 10 which is a device used by a user includes the screen lock function. For reference, the screen lock function which is a function for reducing an unnecessary input error in a standby state provides an unlock screen enabling only a limited input in the standby state, and cancels a screen lock mode when a predetermined password or pattern is input, so that the original standby screen of the terminal 10 to which an input is not limited may be output.

According to the present invention, such a terminal 10 provides mission execution information that requires user participation through the unlock screen when the unlock screen is output, provides a mission execution screen for execution of a mission by activating an electronic wallet when there is a request for mission execution through the unlock screen, and then requests, from the service device, an additional service which is set to correspond to the mission when the execution of the mission is completed on the mission execution screen. Here, the additional service may include at least one of point payment and coupon issue, and the mission may be additional service card issue, coupon issue, and the like as a mission associated with the use of the electronic wallet.

In addition, the terminal 10 may output predetermined advertising contents through the mission execution screen. Here, the advertising contents may be targeted for each user according to location, age, occupation, sex, etc., of the user.

The service device 20 is connected to the terminal 10 via the communication network 30 to transmit and receive all kinds of data for the wallet service. In particular, the service device 20 according to the present invention collects additional information associated with the wallet service. At this point, the service device 20 collects the additional information by matching additional information collected from payment service companies and service providing companies with image information corresponding to the additional information. Next, the service device 20 transmits the collected additional information to the terminal 10 through the wallet application in real time.

The service device 20 determines detailed information about the additional information requested through the wallet application in response to cancellation of a screen lock function of the terminal 10. At this point, the service device 20 determines the additional information including detailed information of at least one of recommended card information, advertising information, discount information, and coupon information. Next, the service device 20 provides the determined detailed information to the terminal 10.

The service device 20 is a component for providing an additional service in conjunction with the terminal 10. For example, the service device 20 according to the present invention may be a server device that provides an electronic wallet service for managing one or more credit cards and additional service cards.

According to an embodiment of the present invention, the service device 20 may set mission execution information that requires user participation through the unlock screen of the terminal 10, provide the mission execution information to the terminal in response to a request from the terminal 10, and then provide a mission execution screen for execution of a mission by activating an electronic wallet provided in the terminal 10 when there is a request for mission execution through the unlock screen of the terminal 10. Further, the service device 20 may provide a predetermined additional service according to whether the mission is completely executed.

In addition, the service device 20 may collect advertising condition information that defines one or more advertising contents and an environment to which the advertising contents are output and user information associated with a user of one or more terminals, compare the user information and the advertising condition information, set the terminal to which each of the advertising contents is to be provided, and then provide the advertising contents through the mission execution screen of the corresponding terminal.

Accordingly, according to the present invention, information about an installed application other than images or text phrases set by a user may be provided in advance on a screen-lock screen of a terminal, thereby helping user convenience. In addition, payment card or coupon information may be provided on the screen-lock screen, thereby increasing a use opportunity of a wallet application. In addition, the payment card or the coupon information provided on the screen-lock screen may be targeted and provided depending on ages of users, thereby enabling efficient marketing.

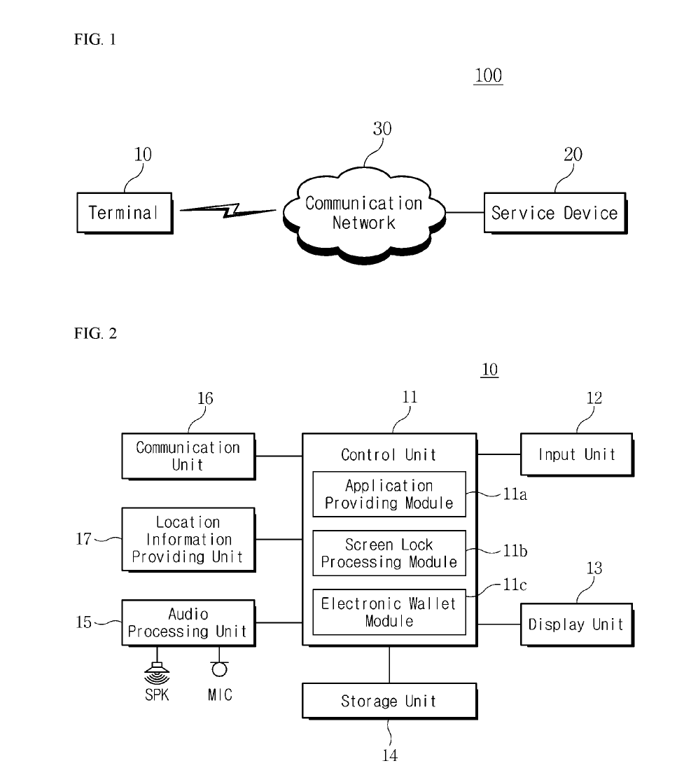

The above-described process of providing additional information through a control of a screen lock function according to an embodiment of the present invention will be described in more detail with reference to FIGS. 2 to 6C.

FIG. 2 is a block diagram showing constituent components of a terminal according to the present invention.

Referring to FIG. 2, the terminal 10 according to the present invention includes a control unit 11, an input unit 12, a display unit 13, a storage unit 14, an audio processing unit 15, a communication unit 16, and a location information providing unit 17. Here, the control unit 11 includes an application providing module 11a.

The input unit 12 receives a variety of pieces of information such as numeral information, character information, etc., and transmits signals input in association with setting of various functions and a function control of the terminal 10, to the control unit 11. In addition, the input unit 12 may include at least one of a keypad and a touch pad which generate an input signal according to a user's touch or operation. At this point, the input unit 12 may be provided in the form of a single touch panel (or a touch screen) together with the display unit 13, thereby simultaneously performing input and display functions. In addition, as the input unit 12, any type of input means which will be developed in the future in addition to input devices such as a keyboard, a keypad, a mouse, a joystick, etc., may be used. In particular, the input unit 12 according to the present invention detects an input signal for a lock function control of the terminal and an input signal for operation of the wallet application, and transmits the detected input signal to the control unit 11. In addition, the input unit 12 may be used for user inputs associated with an unlock pattern input, a mission execution request, game execution, etc., which are carried out on an unlock screen.

The display unit 13 displays information about a series of operating conditions and operating results that occur during function execution of the terminal 10, and the like. In addition, the display unit 13 may display menus of the terminal 10, user data input by a user, and the like. Here, the display unit 13 may include an LCD (liquid crystal display), a TFT-LCD (thin film transistor LCD), an LED (light emitting diode), an OLED (organic LED), an AMOLED (active matrix OLED), a retina display, a flexible display, a three-dimensional (3D) display, and the like. At this point, the display unit 13 may perform some or all of the functions of the input unit 12 when it is provided in the form of a touch screen. In particular, the display unit 13 according to the present invention outputs a standby mode of the terminal 10, a lock screen applied to the standby mode of the terminal, additional information provided through the wallet application, image information about the additional information, and the like.

The display unit 13 may output the unlock screen including mission execution information and a mission execution screen. The unlock screen and the mission execution screen may be implemented by a GUI (graphic user interface) that represents functions and applications using graphic elements.

The storage unit 14 that is a device for storing data includes a main storage device and an auxiliary storage device, and stores application programs required for functional operations of the terminal 10. Such a storage unit 14 may roughly include a program area and a data area. Here, when each function is activated in response to a user's request, the terminal 10 provides each function by executing the corresponding application programs under a control of the control unit 11. In particular, the storage unit 14 according to the present invention stores an operating system (OS) that boots the terminal 10, a program, or the like. In addition, the storage unit 14 stores a program for executing the wallet application, a program for receiving additional information through the wallet application, a program for extracting image information corresponding to additional information, a program for controlling a screen lock function, a program for providing additional information in response to cancellation of a screen lock function.

In addition, the storage unit 14 may store screen images or the like which are required for data processed during the operation of the control unit 11 and functional operations according to embodiments of the present invention. When the display unit 13 is provided in the form of a touch screen, the storage unit 14 may store a key map, a menu map, or the like for the operation of the touch screen. Here, each of the key map and the menu map may have various types. That is, the key map may be a keyboard map, a 3*4 key map, a qwerty key map, or the like, and also a control key map for an operation control of an application program which is currently activated. In addition, the menu map may be a menu map for an operation control of an application program which is currently activated.

The audio processing unit 15 performs a function for transmitting audio signals, which are input from a speaker (SPK) for reproducing and outputting audio signals or a microphone (MIC), to the control unit 11. Such an audio processing unit 15 may convert analog audio signals input through the microphone into digital signals, and transmit the converted signals to the control unit 11. In addition, the audio processing unit 15 may convert digital audio signals output from the control unit 11 into analog signals, and output the converted signal via the speaker. In particular, the audio processing unit 15 according to the present invention outputs a sound effect or a sound for execution according to the execution of the wallet application or the screen lock function.

The communication unit 16 performs a function for transmitting and receiving data to and from the service device 20 via the communication network 30. Here, the communication unit 16 includes an RF transmission means that up-converts and amplifies a frequency of a transmitted signal, an RF reception means that low-noise amplifies a received signal and down-converts a frequency, and the like. Such a communication unit 16 may include at least one of a wireless communication module (not shown) and a wired communication module (not shown). The wireless communication module is a component for transmitting and receiving data according to a wireless communication method, and may transmit and receive data to and from the service device 20 using any one of a wireless network communication module, a wireless LAN communication module, and a wireless PAN communication module when the terminal 10 uses wireless communication. In addition, the wired communication module is used for transmitting and receiving data in a wired manner. The wired communication module may be connected to the communication network 30 in a wired manner, thereby transmitting and receiving data to and from the service device 20. In particular, the communication unit 16 according to the present invention communicates with the service device 20 to transmit and receive data associated with providing of additional information through a control of the screen lock function.

The location information providing unit 17 receives GPS (global positioning system) signals from one or more GPS satellites by a control of the control unit 11 to determine current location information including the latitude and longitude of the terminal 10, and transmits the determined information to the control unit 11. However, when using only signals received from the GPS satellites, an error may occur, and therefore the location information providing unit 17 may operate round trip delay information transmitted from a base station, pilot phase file information, and the like together with the GPS signals in order to obtain accurate location information. Here, the base station plays two roles. One is to relay data transmission between a communication center and the terminal 10, and the other one is to transmit data used for determining a location of the terminal 10, that is, a user's location. Thus, the location information providing unit 17 may receive the above-described location information to determine the location of the corresponding terminal 10, or receive the location information from three or more base stations to determine current location information of the terminal 10 using trigonometry or the like for determining an accurate location.

The location information providing unit 17 may perform positioning on location information of the terminal 10 by applying a BLE (Bluetooth low energy) method and an NFC (near field communication) tag method. That is, the location information providing unit 17 may determine the user's location indoors by applying an IPS (indoor positioning system), and determine a minute change in the user's location within a building using the IPS. Such an IPS may be easily applied to most of offline stores and the real world so that its utilization field is very wide. In particular, using a data communication technology utilizing BLE among IPS services, a user's location reaching from 5 cm to 49 m may be recognized. In addition, the location information providing unit 17 may determine location information by applying an NFC method, and the NFC method as one of wireless tag (RFID) technologies is contactless communication using a frequency band of 13.56 MHz and thereby has relatively excellent security due to its short communication distance.

The control unit 11 may be a process device that drives an OS and respective components. In particular, the control unit 11 according to an embodiment of the present invention receives additional information through the wallet application. Here, the additional information includes detailed information of at least one of recommended card information associated with a payment service or a membership service, advertising information, discount information, and coupon information. The control unit 11 temporarily stores the additional information received from the service device 20 in a buffer.

The control unit 11 extracts image information corresponding to the received additional information. At this point, the control unit 11 extracts image information including at least one of an icon representing the additional information, a discount rate image, and a coupon image.

When the screen lock function is set in the standby mode, the control unit 11 outputs received image information on one side of the screen. That is, the control unit 11 determines whether the screen lock function for activation of the standby mode is set. At this point, the control unit 11 recognizes at least one piece of security information of drag, pattern recognition, face recognition, voice recognition, fingerprint recognition, biometric recognition, a password, and a PIN in order to cancel the screen lock function.

When the screen lock function is cancelled, the control unit 11 provides additional information associated with the image information by automatically executing the wallet application. Here, the control unit 11 detects a signal for selecting a display area of the image information output in the standby mode, and after selecting the display area, automatically executes the wallet application according to a setting for cancelling the input screen lock function. Meanwhile, the control unit 11 limits provision of the additional information when the screen lock function is cancelled, without selecting the display area of the image information output in the standby mode.

In addition, the control unit 11 according to an embodiment of the present invention stores location information of a corresponding store associated with at least one of recommended card information, advertising information, discount information, and coupon information. That is, the control unit 11 may extract the location information associated with a recommended card, advertising, discount, coupon, etc., and store the extracted location information. Next, the control unit 11 determines current location information, and outputs information about the at least one of recommended card information, advertising information, discount information, and coupon information on the screen when the determined current location information is matched with the stored location information. At this point, when the terminal 10 approaches a location indicted by the stored location information according to a user's movement, the control unit 11 may output the at least one of recommended card information, advertising information, discount information, and coupon information on the lock screen. In this case, the terminal 10 may provide the at least one of recommended card information, advertising information, discount information, and coupon information even without communication with the service device 20.

In addition, the control unit 11 according to an embodiment of the present invention receives, from the service device 20, an item existing in the same category as a coupon or a discount card among membership services with previously used histories. Next, the control unit 11 may classify the received item into location information or a time zone corresponding to the received item and store the location information or the time zone. Next, the control unit 11 determines the current location information or a current time zone, and outputs the at least one of recommended card information, advertising information, discount information, and coupon information on the screen when the determined current location information or time zone is matched with the stored location information or time zone. That is, when the terminal 10 approaches a location indicated by the stored location information or when a time zone set in advance comes, the control unit 11 may output the at least one of recommended card information, advertising information, discount information, and coupon information on the lock screen.

In addition, the control unit 11 according to the present invention receives, from the service device 20, information about the at least one of recommended card information, advertising information, discount information, and coupon information which can be applied to a recommended time zone, and store the received information. Next, the control unit 11 determines whether a specific time zone is matched with the recommended time zone when the specific time zone comes, determines whether to have additional information corresponding to the time zone when the specific time zone coincides with the recommended time zone, and outputs the additional information on the screen according to whether to have the additional information. For example, the control unit 11 may determine patterns of use of a user's card or membership, tendency to consume, etc., in order to target a user, receive and store additional information matched with the recommended time zone from the service device 20 in advance, and then recommend the additional information matched with the time zone to the user within the terminal 10 when the corresponding time zone comes.

In particular, in order to provide an additional service using a screen lock mode according to the present invention, the control unit 11 may include a screen lock processing module 11b and an electronic wallet module 11c. Here, the ‘module’ may refer to a component of a functional unit which is implemented by software or hardware or a combination of software and hardware and performs a predetermined function. Each of the screen lock processing module 11b and the electronic wallet module 11c according to the present invention may be implemented such that a screen lock application and an electronic wallet application are installed to perform the screen lock function and a processor mounted in the terminal 10 executes a messenger service-related application.

The screen lock processing module 11b implemented and operated in the above-mentioned manner outputs the unlock screen to which an input is limited at the time of a screen lock setting, and outputs the mission execution information through the unlock screen while switching the unlock screen to a standby screen of the terminal 10 to which an input is not limited, when an unlock pattern set in advance is input.

The electronic wallet module 11c is a component for supporting online electronic payment based on the communication network 30, and may basically support issue of one or more credit cards, additional service cards, etc., payment using the issued credit cards, and point accumulation and use through the additional service cards.

According to the present invention, the electronic wallet module 11c may set the mission execution information output through the screen lock processing module 11b in addition to the above-described basic functions, and be activated to provide a mission execution screen when there is a request for mission execution through the unlock screen, so that a user may execute a predetermined mission set in advance. Next, the electronic wallet module 11c requests, from the service device 20, an additional service that is set to correspond to the corresponding mission according to a result of the execution of the mission which is carried out through the mission execution screen. Here, predetermined advertising contents targeted to a user may be provided through the mission execution screen.

In addition, the electronic wallet module 11c may provide a game set in advance as mission execution information through the unlock screen before providing the mission execution screen, and provide the mission execution screen when the game is completed by the user. At this point, the electronic wallet module 11c may collect user information of the terminal 10, compare the collected user information with a service providing condition set in advance, and provide the game according to a result of the comparison. Here, the service providing condition may be set considering at least one of whether an additional service card that can be provided through the electronic wallet module 11c is issued, whether the additional service card is used, and a period of time. In this manner, by providing the predetermined game and providing the mission execution screen according to whether the game is completed, it is possible to improve the user's attention and a sense of accomplishment, and increase the service utilization.

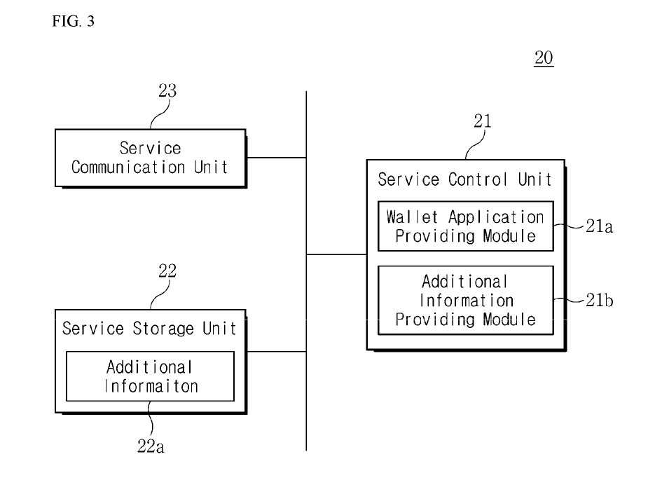

FIG. 3 is a block diagram showing constituent components of a service device according to the present invention.

Referring to FIG. 3, the service device 20 according to the present invention includes a service control unit 21, a service storage unit 22, and a service communication unit 23. Here, the service control unit 21 includes a wallet application providing module 21a and an additional information providing module 21b, and the service storage unit 22 includes additional information 22a.

The service communication unit 23 transmits and receives data associated with additional information provision through a control of a screen lock function of one or more terminals via the communication network 30.

The service storage unit 22 stores all programs according to execution of the function of the service device 20. In particular, the service storage unit 22 according to the present invention stores a program for providing a wallet application, a program for collecting additional information associated with a wallet service, a program for generating image information corresponding to additional information, a program for providing additional information and image information, a program for providing detailed information associated with additional information, etc. In addition, the service storage unit 22 stores the additional information 22a for a wallet service. Here, the additional information includes detailed information of at least one of recommended card information, advertising information, discount information, and coupon information which are associated with a payment service or a membership service.

The service control unit 21 may be a process device that drives an OS and respective components. In particular, the service control unit 21 according to an embodiment of the present invention collects additional information associated with the wallet service. Next, the service control unit 21 transmits the collected additional information to one or more terminals through a wallet application. Here, the service control unit 21 matches the additional information collected from payment service companies and service providing companies with image information corresponding to the additional information, and transmits the matched information to the one or more terminals in real time.

The service control unit 21 determines detailed information about the additional information requested through the wallet application in response to cancellation of a screen lock function of the terminal 10. At this point, the service control unit 21 determines the additional information including detailed information of at least one of recommended card information, advertising information, discount information, and coupon information. Next, the service control unit 21 provides the determined detailed information to the corresponding terminal. Meanwhile, when a payment service is executed by applying the additional information provided through the wallet service, the service control unit 21 may further apply and provide an accumulation rate.

In addition, the service control unit 21 according to an embodiment of the present invention sets a recommended time zone that a user prefers with respect to the terminal 10. At this point, the service control unit 21 may analyze the payment service or the membership service using the wallet application, thereby analyzing a usage history of the user. Next, the service control unit 21 may transmit the at least one of recommended card information, advertising information, discount information, and coupon information to the corresponding terminal 10 when the time zone set in advance comes.

In addition, the service control unit 21 according to an embodiment of the present invention determines the frequency of use of a coupon or a discount card among the membership services with respect to the terminal 10. Next, the service control unit 21 extracts an item existing in the same category as the coupon or the discount card which is used by a user. At this point, the service control unit 21 may classify the categories according to types of businesses, types of services, service areas, etc., and determine the same category. Next, the service control unit 21 may transmit the extracted item to the terminal 10.

The service control unit 21 according to embodiments of the present invention controls a process of providing a screen lock mode-based additional service in conjunction with two or more terminals 10 via the communication network 30. Specifically, the service control unit 21 sets mission execution information to be provided through an unlock screen of the terminal 10. The mission execution information may be provided in various forms such as a guidance message, a game, and the like, as information associated with a predetermined mission that requires user participation. In addition, the service control unit 21 provides the mission execution information to the terminal 10 in response to a request from the terminal 10, provides a mission execution screen in conjunction with the electronic wallet module 11c provided in the terminal 10 when there is a request for mission execution through the unlock screen of the terminal 10, and then provides an additional service set in advance according to whether the mission is completely executed.

Here, the service control unit 21 may collect user information of the terminal 10, compare the collected user information with a service providing condition set in advance to select and provide a game, and provide the mission execution screen when the game is completed.

Here, the service providing condition that is related to use of the electronic wallet as described above may be set based on whether an additional service card is issued or used. For example, when a user is not issued a specific additional service card or does not use the specific additional service card for a predetermined period of time, the service control unit 21 may provide the game in order to increase the utilization of the specific additional service card.

In addition, the service control unit 21 may guide a result of the provision of the additional service to the terminal 10 through a text message service. As a result, the user may determine that the additional service (for example, point accumulation) has been provided only by checking the text message.

In addition, according to another embodiment of the present invention, the service control unit 21 may combine and provide the additional service and a targeting advertisement. That is, the service control unit 21 may collect advertising condition information that defines one or more advertising contents and an environment to which the advertising contents are output and user information associated with a user of one or more terminals 10, compare the user information and the advertising condition information, set the terminal to which each of the advertising contents is to be provided, and then control to output the targeted advertising content through the mission execution screen when the mission execution screen of the set terminal is output.

In addition, the service device 20 configured as above may be implemented by one or more servers which is operated in a computing-based method based on a server or a cloud method. In particular, data for a wallet service may be provided through a cloud computing function that can be stored permanently in a cloud computing device on the Internet. Here, the cloud computing may refer to a technology that services virtualized IT (information technology) resources, for example, hardware (a server, a storage, a network, etc.), software (a database, security, a web server, etc.), services, data, and the like to digital terminals such as a desktop, a tablet computer, a notebook, a Netbook, a smart phone, etc., in an on-demand method by utilizing Internet technologies.

Meanwhile, a memory mounted in the terminal 10 or the service device 20 stores information within the terminal 10 or the service device 20. In a case of an implementation example, the memory is a computer-readable medium. In one implementation example, the memory may be a volatile memory unit, and in another implementation example, the memory may be a non-volatile memory unit. In the case of the one implementation example, a storage device may be a computer-readable medium. In various different implementation examples, the storage device may include, for example, a hard disk device, an optical disk device, or any other large-capacity storage device.

Although the structures of devices are exemplarily described in the present specification and drawings, the embodiments of functional operations and subject matters described in the present disclosure may be realized using different types of digital electronic circuits; computer software, firmware, or hardware including the structures disclosed herein or equivalents thereof; or a combination of at least one among them. The embodiments of the subject matters described in the present disclosure may be realized as at least one computer program product, in other words, at least one module regarding an encoded computer program command stored in a program storage medium so as to control an operation of a device according to the present invention or perform the operation of the device. The computer-readable medium may be a storage device that can be read by a machine, a storage substrate that can be read by a machine, a memory device, a composition of a material that affects a propagated signal that can be read by a machine, or a combination of at least one among them.

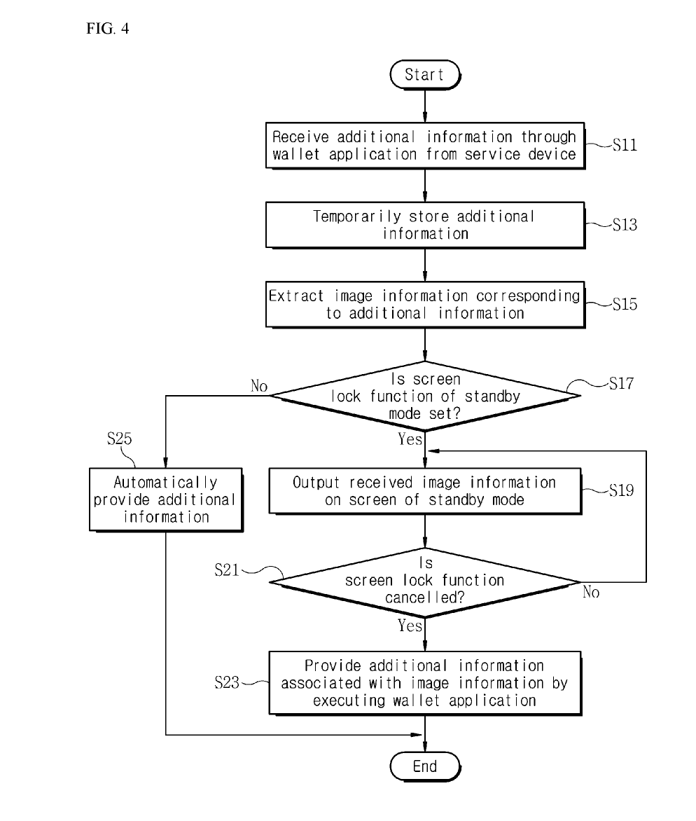

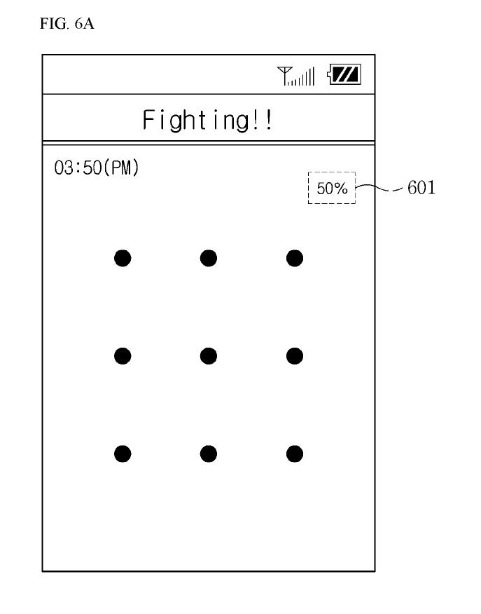

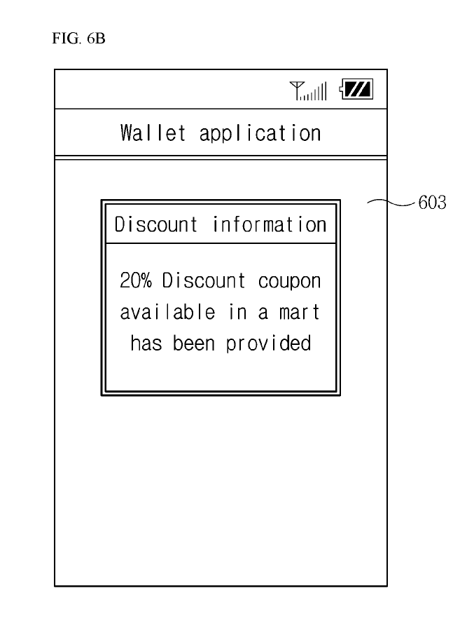

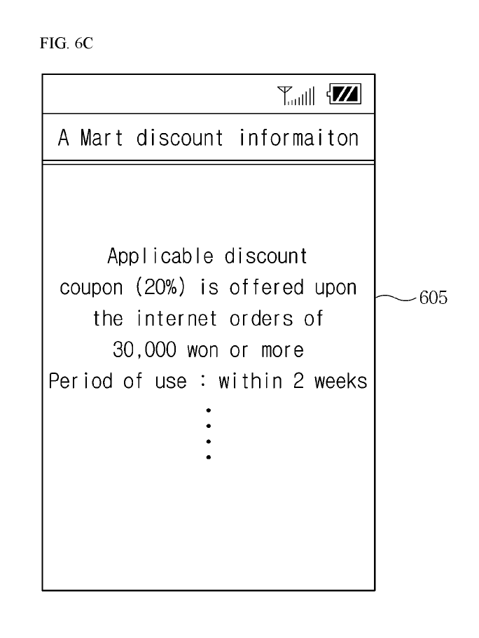

FIG. 4 is a flowchart for describing an operation method of a terminal according to an embodiment of the present invention, and FIGS. 6A to 6C are exemplary views for describing a process of providing additional information through a control of a screen lock function according to an embodiment of the present invention.

Referring to FIG. 4, the terminal 10 that provides additional information through a control of a screen lock function according to the present invention receives additional information through a wallet application in operation S11. Here, the additional information includes detailed information of at least one of recommended card information associated with a payment service or a membership service, advertising information, discount information, and coupon information. Next, in operation S13, the terminal 10 temporarily stores the additional information received from the service device 20 in a buffer.

In operation S15, the terminal 10 extracts image information corresponding to the received additional information. At this point, the terminal 10 extracts the image information including at least one of an icon, a discount rate image, and a coupon image which represent additional information.

In operation S17, the terminal 10 determines whether a screen lock function is set in a standby mode. In operation S19, when the screen lock function is set in the standby mode, the terminal 10 outputs the received image information on one side of a screen. That is, the terminal 10 determines whether the screen lock function for activation of the standby mode is set. At this time, the terminal 10 recognizes at least one piece of security information of drag, pattern recognition, face recognition, voice recognition, fingerprint recognition, biometric recognition, a password, and a PIN in order to cancel the screen lock function.

In operation S21, the terminal 10 determines whether the screen lock function is cancelled. In operation S23, when the screen lock function is cancelled, the terminal 10 provides additional information associated with image information by automatically executing a wallet application. Here, the terminal 10 detects a signal for selecting a display area of the image information output in the standby mode, selects the display area, and then automatically executes the wallet application according to a setting for cancelling the input screen lock function. Meanwhile, the terminal 10 limits provision of the additional information when the screen lock function is cancelled, without selecting the display area of the image information output in the standby mode.

In addition, in operation S25, when the screen lock function of the standby mode is not set, the terminal 10 controls the additional information to be automatically provided.

For example, as shown in FIGS. 6A to 6C, when additional information (discount information) for a wallet service is received from the service device 20 in the standby mode, the terminal 10 extracts image information 601 corresponding to the additional information and outputs the extracted image information 601 as an icon on the screen. Next, the terminal 10 automatically executes the wallet application according to the cancellation of the screen lock function, and provides the additional information on a screen 603 through the wallet service. Next, the terminal 10 may additionally provide detailed information about the additional information on a screen 605 according to a user's selection.

In addition, the terminal 10 according to an embodiment of the present invention stores location information of a corresponding store associated with at least one of recommended card information, advertising information, discount information, and coupon information. That is, the terminal 10 may extract the location information associated with information such as a recommended card, an advertisement, discount, a coupon, and the like, and store the extracted information. Next, the terminal 10 determines current location information, and outputs the at least one of recommended card information, advertising information, discount information, and coupon information on the screen when the determined current location information is matched with the stored location information. At this time, the terminal 10 may output the at least one of recommended card information, advertising information, discount information, and coupon information on a lock screen when it approaches a location indicated by the stored location information according to a user's movement. In this case, the terminal 10 may provide the at least one of recommended card information, advertising information, discount information, and coupon information even without communication with the service device 20.

In addition, the terminal 10 according to an embodiment of the present invention receives, from the service device 20, an item existing in the same category as a coupon or a discount card among membership services with previously used histories. Next, the terminal 10 may classify the received item into location information or a time zone corresponding to the received item and store the location information or the time zone. Next, the terminal 10 determines current location information or a current time zone, and outputs the at least one of recommended card information, advertising information, discount information, and coupon information on the screen when the determined current location information or time zone is matched with the stored location information or time zone. That is, the terminal 10 may output the at least one of recommended card information, advertising information, discount information, and coupon information on the lock screen, when it approaches a location indicated by the stored location information or when a time zone set in advance comes.

In addition, the terminal 10 according to the present invention receives, from the service device 20, the at least one of recommended card information, advertising information, discount information, and coupon information which can be applied to a recommended time zone, and stores the received information. Next, the terminal 10 determines whether a specific time zone is matched with the recommended time zone when the specific time zone comes, determines whether to have additional information corresponding to the time zone when the specific time zone coincides with the recommended time zone, and outputs the additional information on the screen according to whether to have the additional information. For example, the terminal 10 may determine patterns of use of a user's card or membership, tendency to consume, etc., in order to target a user, receive and store additional information matched with the recommended time zone from the service device 20 in advance, and then recommend the additional information matched with the time zone to the user within the terminal 10 when the corresponding time zone comes.

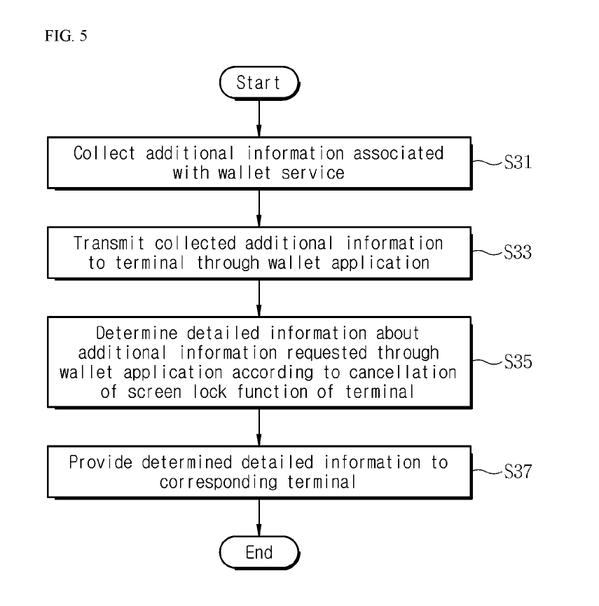

FIG. 5 is a flowchart for describing an operation method of a service device according to an embodiment of the present invention.

Referring to FIG. 5, in operation S31, the service device 20 that provides additional information through a control of a screen lock function according to the present invention collects additional information associated with a wallet service. Then, the service control unit 21 transmits the collected additional information to one or more terminals through a wallet application. Here, in operation S33, the service device 20 matches the additional information collected from payment service companies and service providing companies with image information corresponding to the additional information, and transmits the matched information to the one or more terminals in real time.

In operation S35, the service device 20 determines detailed information about the additional information requested through the wallet application in response to cancellation of the screen lock function of the terminal 10. At this time, the service control unit 21 determines the additional information including detailed information of at least one of recommended card information, advertising information, discount information, and coupon information. Next, in operation S37, the service device 20 provides the determined detailed information to the corresponding terminal. Meanwhile, when a payment service is executed by applying the additional information provided through the wallet service, the service device 20 may further apply an accumulation rate and provide the applied accumulation rate to a user.

In addition, the service device 20 according to an embodiment of the present invention sets a recommended time zone that a user prefers with respect to the terminal 10. At this point, the service device 20 may analyze the payment service or the membership service using the wallet application, thereby analyzing a usage history of the user. Next, the service device 20 may transmit the at least one of recommended card information, advertising information, discount information, and coupon information to the corresponding terminal 10 when the time zone set in advance comes.

In addition, the service device 20 according to an embodiment of the present invention determines the frequency of use of a coupon or a discount card among the membership services with respect to the terminal 10. Next, the service device 20 extracts an item existing in the same category as the coupon or the discount card which is used by a user. At this point, the service device 20 may classify the categories according to types of businesses, types of services, service areas, etc., and determine the same category. Next, the service device 20 may transmit the extracted item to the terminal 10.

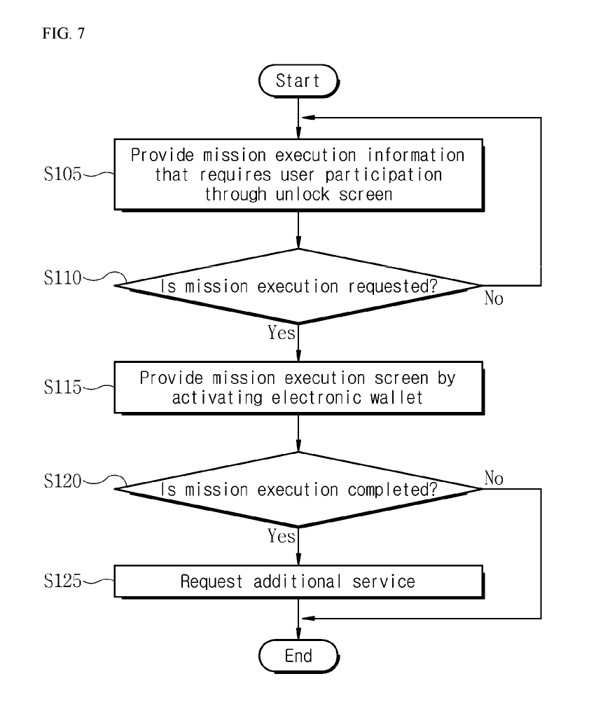

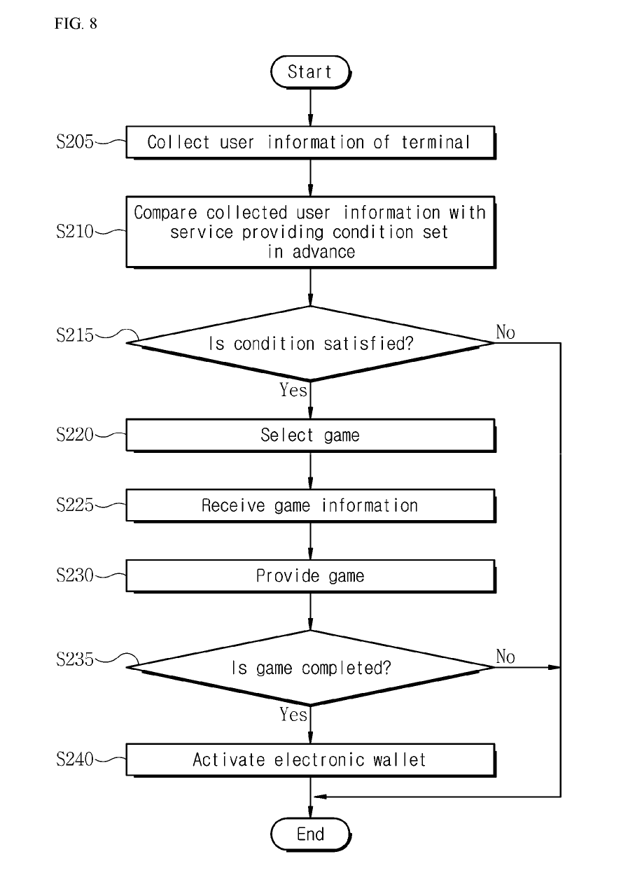

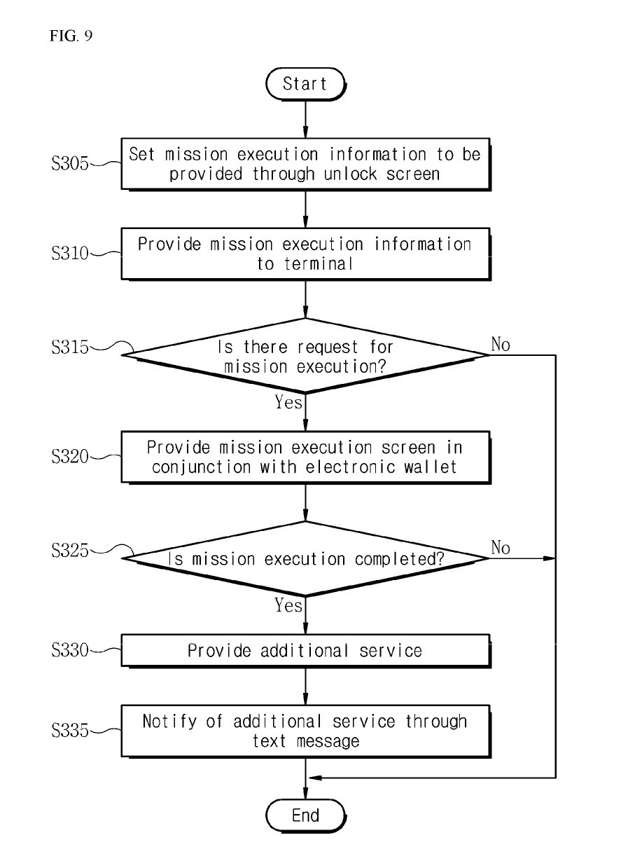

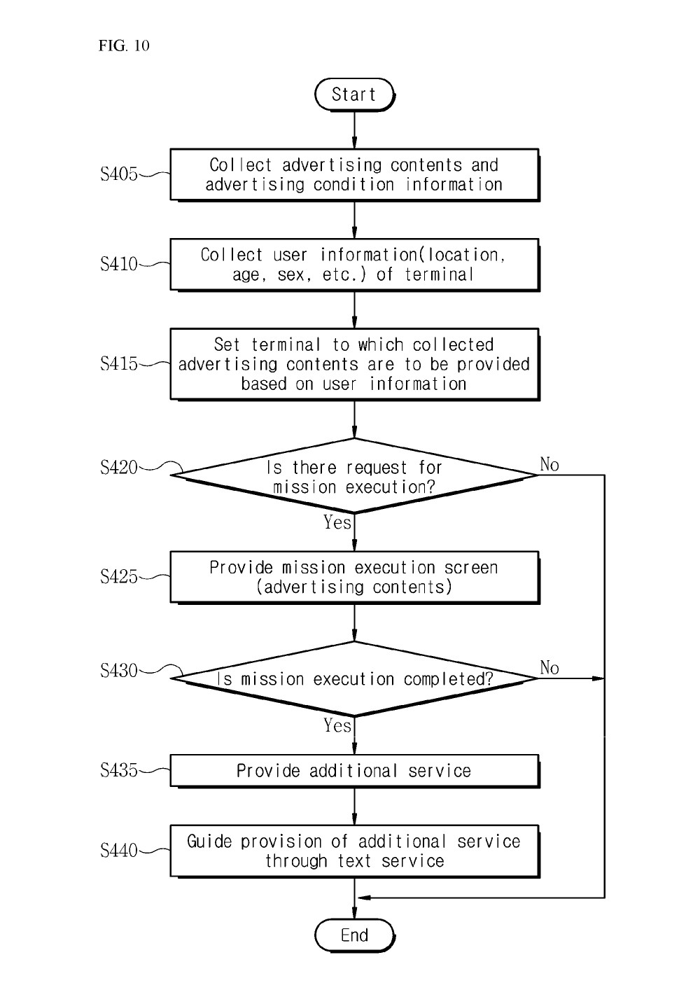

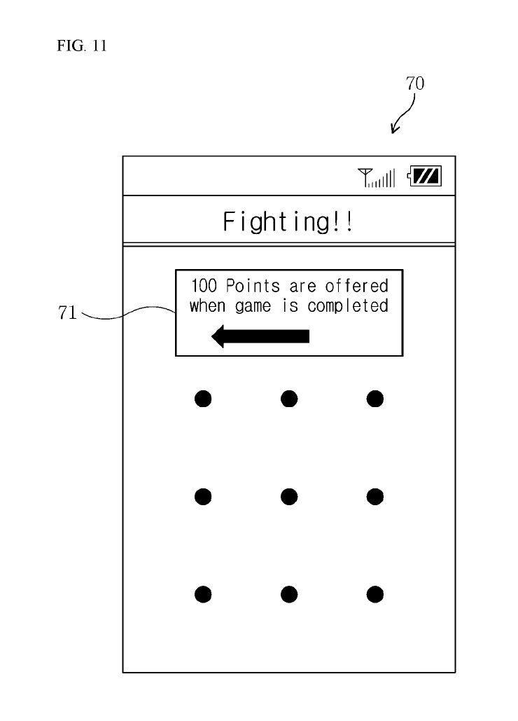

FIGS. 7 and 8 are flowcharts showing a method for providing an additional service using a screen lock mode executed by a terminal according to an embodiment of the present invention, FIG. 9 is a flowchart showing a method for providing an additional service using a screen lock mode executed by a service device according to an embodiment of the present invention, FIG. 10 is a flowchart showing a method for providing an additional service using a screen lock mode executed by a service device according to another embodiment of the present invention, and FIG. 11 is an exemplary view of an unlock screen provided according to the present invention.

First, referring to FIG. 7, when there is no user input for a predetermined time or more, the terminal 10 activates a screen lock mode. When a predetermined user input set in advance occurs in the screen lock mode, an unlock screen to which an input is limited is output, and when an unlock pattern (or a password) set in advance is input through the unlock screen, the screen lock mode is cancelled and switched into a standby mode, so that the terminal 10 may be in an available state.

In operation S105, when the unlock screen is output during execution of the screen lock mode, the terminal 10 provides mission execution information that requires user participation through the unlock screen. The mission execution information may be provided in the form of a guidance message or a predetermined game. FIG. 11 is an exemplary view of an unlock screen provided according to an embodiment of the present invention. Referring to FIG. 11, within an unlock screen 70 in which an input pattern can be drawn, mission execution information 71 for guiding provision of a predetermined additional service is provided. The mission execution information 71 includes GUI elements (for example, arrows) capable of requesting mission execution.

Next, in operation S110, the terminal 10 determines whether mission execution is requested through the unlock screen. That is, when a predetermined input (for example, touch of an arrow, flicking or sliding in the direction of the arrow, or the like) occurs according to the guidance of the mission execution information 71 on the unlock screen 70 as shown in FIG. 11, it can be recognized that the mission execution is requested.

Next, in operation S115, when the mission execution is requested on the unlock screen, the terminal 10 provides a mission execution screen for executing a mission set in advance by activating an electronic wallet, that is, the electronic wallet module 11c. The mission execution screen refers to a screen through which a predetermined mission associated with the electronic wallet can be processed, for example, a screen capable of issuing a specific additional service card or being issued a coupon.

Here, the terminal 10 may use a game in order to attract a user's attention and select a user to whom the additional service is to be provided.

That is, as shown in FIG. 8, the terminal 10 may preferentially collect user information in operation S205, and compare the collected user information with a service providing condition set in advance in operation S210. The service providing condition set in advance may be set based on whether an additional service card using the electronic wallet is issued and a use result of the additional service card issued through the electronic wallet, and the user information may be user usage information associated with the electronic wallet through the electronic wallet module 11c.

Next, when the service providing condition set in advance is satisfied in operation S215, the terminal 10 may select a game based on the user information and provide the selected game to the user in operations S220 to S230. At this point, the terminal 10 may be connected to the service device 20 to receive game information (for example, a game application, etc.) to be provided to the user, and provide the received game to the user. Accordingly, the user may execute the game through the terminal 10.

At this point, in operation S235, the terminal 10 determines whether the game is completed. That is, the terminal 10 determines whether predetermined missions provided from the game are all executed.

In operation S240, when the game is completed based on the determination result, the terminal 10 provides the mission execution screen for provision of the additional service by activating the electronic wallet module 11c in order to provide the additional service.

Referring again to FIG. 7, after the mission execution screen is output, the terminal 10 determines whether a designated mission is executed through the mission execution screen in operation S120. That is, the terminal 10 determines whether a specific additional service is issued or a coupon is issued.

Next, in operation S125, when the execution of the mission is completed on the mission execution screen, the terminal 10 requests an additional service set to correspond to the mission from the service device 20. The additional service may be provided in such a manner as to provide a point set in advance to the issued additional service card.

Next, the terminal 10 may receive information about whether the requested additional service is provided through a text message.

Hereinafter, operations of the service device 20 will be described with reference to FIG. 9.

Referring to FIG. 9, in operation S305, the service device 20 sets mission execution information to be provided through the unlock screen of the terminal 10. The mission execution information may be mission-related information that requires user participation, and set according to requests of affiliates of electronic wallet services.

Next, in operation S310, the service device 20 provides the set mission execution information to the terminal 10 in response to a request from the terminal 10. At this point, the service device 20 may collect user information, compare the collected user information with a service providing condition set in advance, and provide the mission execution information when the service providing condition is satisfied.

Next, the service device 20 determines whether mission execution is requested from the terminal 10 in operation S315 after providing the mission execution information, and provides a mission execution screen set in advance in conjunction with the terminal 10, particularly, the electronic wallet module 11c when the mission execution is requested. At this point, the service device 20 may provide a predetermined game set in advance, and provide the mission execution screen according to whether the game is completed.

Next, in operation S330, when the completion of the mission execution is reported from the terminal 10, the service device 20 provides the set additional service to a user of the terminal 10. The additional service may be provided in a predetermined point accumulation method as described above.

In addition, in operation S335, the service device 20 may provide a result of the provision of the additional service to the terminal 10 through a text message service.

Subsequently, FIG. 10 is a flowchart showing a method for providing an additional service using a screen lock mode executed by a service device according to another embodiment of the present invention.

Referring to FIG. 10, in operation S405, the service device 20 according to another embodiment of the present invention collects one or more advertising contents and advertising condition information about the advertising contents. Here, the advertising contents which are advertising contents to be provided through a screen lock mode according to the present invention may be provided in various forms such as images, videos, web pages, games, etc., and the advertising condition information may be information that defines an environment (time, location, age, sex, etc.) that provides the corresponding advertising contents. Such advertising contents and advertising condition information may be collected from an advertising requester, for example, a small or large nonprofit or profit organization, or an individual business.

Next, in operation S410, the service device 20 collects user information about a large number of terminals to which an additional service is to be provided using the screen lock mode. Here, the user information which is information indicating a user environment using the terminal may include, for example, location, age, sex, occupation, etc.

Next, in operation S415, the service device 20 sets the terminal to which the collected advertising contents are to be provided based on the collected user information. That is, the service device 20 sets the terminal that is a target of the corresponding advertising contents according to an advertising condition which the advertising requester suggests. For reference, according to the present invention, the advertising contents may be set as mission execution information to be provided through the unlock screen.

Next, in operation S420, the service device 20 provides the set advertising contents to the user through the terminal 10 in response to a request for mission execution from the terminal 10. That is, after the service device 20 transmits and stores the advertising contents in advance to the set terminal 10 through a push method or the like 10 in operation S415, operation S420 may be performed in a manner such that the terminal 10 reads and outputs the stored advertising contents when outputting the unlock screen in response to a user's request in a screen lock state. Alternatively, before the terminal 10 outputs the unlock screen in response to the user's request in the screen lock state, operation S420 may be performed in a manner such that the service device 20 transmits the advertising contents to the terminal 10 so that the advertising contents are output through the unlock screen of the terminal 10 when the terminal 10 requests mission execution information from the service device 20. Here, the advertising contents may be output through a mission execution screen provided by the user selecting the mission execution information on the unlock screen as shown in FIG. 8.

Next, after providing the advertising contents through the mission execution screen, the service device 20 provides an additional service set in advance to the user of the terminal 10 in operations S430 and S435, when the completion of the mission execution is reported from the terminal 10. The additional service may be provided in a predetermined point accumulation method, as described above.

In addition, in operation S440, the service device 20 may provide a result of the provision of the additional service to the terminal 10 through a text message service.

The various technologies described in the present disclosure may be embodied using a digital electronic circuit system, computer hardware, firmware, software, or a combination thereof. The various technologies may be also embodied as a computer program embodied using a computer program product, i.e., an information carrier, for example, a machine readable storage medium (a computer readable medium) or a radio signal, so as to perform processing by operating a data processing device, e.g., a programmable processor, a computer, or a plurality of computers, or control an operation of the data processing device. A computer program such as the computer program(s) described above may be recorded in an arbitrary programming language including compiled or interpreted languages, and expanded in an arbitrary form including an individual program, a module, a component, a subroutine, or other units that can be used in a computing environment. The computer program may be distributed to be executed by one computer or a plurality of computers in one site or may be divided and distributed over a plurality of sites and expanded to be connected via a communication network.

The operations of a method may be performed by at least one programmable processor configured to execute a computer program to perform functions by executing ‘on’ input data and outputting an output. The operations of a method may be performed by as a special-purpose logic circuit system, e.g., a field programmable gate array (FPGA) or an application-specific integrated circuit (ASIC), and an apparatus may be embodied as the single-purpose logic circuit system.

For example, processors appropriate for executing a computer program include both a general-purpose microprocessor and a special-purpose microprocessor, and at least one processor of an arbitrary type of digital computer. In general, a processor may receive commands and data from a read only memory, a random access memory, or both of them. The elements of a computer may include at least one processor for executing commands, and at least one memory device for storing commands and data. In general, a computer may include at least one large-capacity storage device for storing data (e.g., magnetic disks, magneto-optical discs, or optical discs) or be combined with the at least one large-capacity storage device to receive data therefrom, transmit data thereto, or transmit data thereto and receive data therefrom. Examples of information carriers appropriate for embodying computer program commands and data include semiconductor memory devices such as magnetic media (e.g., a hard disk, a floppy disk, a magnetic tape, etc.), optical media (e.g., a compact disk-read only memory (CD-ROM), a digital video disk (DVD), etc.), magneto-optical media (e.g., a floptical disk), a ROM, a random access memory (RAM), a flash memory, an erasable programmable ROM (EPROM), an electrically erasable programmable ROM (EEPROM), etc. A processor and a memory may be supplemented with or included in a special-purpose logic circuit system.

Although the details of the exemplary embodiments are described in the present disclosure, they should not be construed as limiting an invention or the scope of an invention to be claimed. Rather, the details of these embodiments should be understood as unique features of exemplary embodiments of a specific invention. The unique features described in the present disclosure may be combined in a single embodiment according to the context of an individual embodiment. On the contrary, various features described according to the context of a single embodiment may be also embodied in a plurality of embodiments individually or in an appropriate sub-combination. Furthermore, although the features may be realized in a particular combination and described as originally claimed, at least one feature according to a claimed combination may be excluded from this combination in some cases and the claimed combination may be changed into a sub-combination or a modification of the sub-combination.

Similarly, although operations are illustrated in a specific order in the drawings, it should not be construed that the operations are performed in the specific order or a sequential order or all of the operations are performed to obtain a desired result. In a particular case, multitasking and parallel processing may be desirable. Also, although various system components may be separated in the embodiments set forth herein, the separation should not be construed as being required in all embodiments. In general, the program components and systems described above may be integrated into a single software product or packaged into multiple software products.

Meanwhile, the embodiments set forth in the present specification and drawings are merely examples provided to help understand the present invention and are not intended to restrict the scope of the present invention. It would be obvious to those of ordinary skill in the art that the above exemplary embodiments are to cover all modifications, equivalents, and alternatives falling within the scope of the invention.

### INDUSTRIAL APPLICABILITY

The present invention relates to a method for providing an additional service using a screen lock mode and a system and apparatus for the same, and more particularly, to a method for providing an additional service using a screen lock mode, which may display additional information which is provided through a wallet service in a screen lock state of a standby mode, on one side of a screen, provide the additional information by automatically executing a wallet application in response to cancellation of a screen lock function or provide, through an unlock screen, mission execution information that requires user participation, provide a mission execution screen for execution of a mission by activating an electronic wallet when there is a request for mission execution through the unlock screen, and then provide an additional service according to a result of the execution of the mission, and a system and apparatus for the same. According to the present invention, information about an installed application other than images or text phrases set by a user may be provided in advance on a screen-lock screen of a terminal, thereby helping user convenience. In addition, payment card or coupon information may be provided on the screen-lock screen, thereby increasing a use opportunity of a wallet application. In addition, the payment card or the coupon information provided on the screen-lock screen may be targeted and provided depending on ages of users, thereby enabling efficient marketing. In addition, when a lock mode of a terminal is cancelled, mission execution information that requires user participation may be provided through an unlock screen, and when there is a request for mission execution through the unlock screen, a mission execution screen for execution of a mission may be provided by activating an electronic wallet, and then an additional service may be provided according to a result of the execution of the mission. In particular, when a predetermined game is completed by providing the game through the unlock screen, the additional service may be provided through the mission execution screen. Accordingly, the present invention may provide, through the unlock screen which a user always uses, a mission associated with the issue and use of an additional service card using the electronic wallet, and provide an additional service such as point payment or coupon issue according to a result of the execution of the mission, thereby increasing the utilization rate of the electronic wallet. The present invention has an industrial applicability in that it can not only be sufficiently marketed or commercialized but also be practically obviously implemented.

1. A service device comprising:
a service communication unit that transmits and receives data associated with provision of additional information through a control of a screen lock function of one or more terminals; and
a service control unit that collects the additional information associated with a wallet service, transmits the collected additional information to the one or more terminals through a wallet application, determines detailed information about the additional information requested through the wallet application from the terminal according to cancellation of the screen lock function of the terminal, and controls the determined detailed information to be provided to the corresponding terminal.

2. The service device according to claim 1, further comprising:
a service storage unit that stores additional information including detailed information of at least one of recommended card information, advertising information, discount information, and coupon information which are provided through the wallet service.

3. The service device according to claim 1, wherein the service control unit sets a recommended time zone with respect to the terminal, and then transmits at least one of recommended card information, advertising information, discount information, and coupon information to the terminal when the recommended time zone comes.

4. The service device according to claim 1, wherein the service control unit determines a frequency of use of a coupon or a discount card among membership services with respect to the terminal, extracts an item existing in the same category as the coupon or the discount card, and transmits the extracted item to the terminal.

5. The service device according to claim 1, wherein the service control unit sets mission execution information that requires user participation, which is to be provided through an unlock screen of the terminal, provides the mission execution information to the terminal in response to a request from the terminal, provides a mission execution screen for executing a mission by activating an electronic wallet provided in the terminal when there is a request for execution of the mission through the unlock screen of the terminal, and provides an additional service set in advance according to whether the execution of the mission is completed.

6. The service device according to claim 5, wherein the service control unit collects user information of the terminal, compares the collected user information with a service providing condition set in advance to select a game, provides the selected game through the unlock screen, and provides the mission execution screen when the game is completed.

7. The service device according to claim 6, wherein the service control unit guides a result of the provision of the additional service to the terminal through a text message service.

8. The service device according to claim 7, wherein the service control unit collects advertising condition information that defines one or more advertising contents and an environment to which the advertising contents are to be output, and outputs the corresponding advertising contents through the mission execution screen of the terminal selected according to the collected advertising condition information.

9. The service device according to claim 8, wherein the advertising condition information is set by combining at least one of user's location, age, occupation, and sex.

10. A terminal comprising:
a communication unit that communicates with a service device to transmit and receive data associated with provision of additional information through a control of a screen lock function; and
a control unit that receives the additional information through a wallet application from the service device, extracts image information corresponding to the received additional information, outputs the extracted image information on one side of a screen when the screen lock function is set in a standby mode, and controls to provide the additional information associated with the image information by executing the wallet application when the screen lock function is cancelled.

11. The terminal according to claim 10, wherein the control unit recognizes at least one piece of security information of drag, pattern recognition, face recognition, voice recognition, fingerprint recognition, biometric recognition, a password, and a PIN (personal identification number) in order to cancel the screen lock function.

12. The terminal according to claim 10, further comprising:
a storage unit that stores location information of a corresponding store capable of using at least one piece of additional information of recommended card information, advertising information, discount information, and coupon information,
wherein the control unit determines current location information, and outputs the additional information on the screen when the determined current location information is matched with the stored location information.

13. The terminal according to claim 10, wherein the control unit receives an item existing in the same category as a coupon or a discount card among membership services from the service device, classifies and stores the received item into location information or a time zone each corresponding to the received item, determines current location information or a current time zone, and outputs the additional information on the screen when the determined current location information or time zone is matched with the stored location information or time zone.

14. The terminal according to claim 10, wherein the control unit receives the additional information applicable to a recommended time zone from the service device to store the received additional information, determines whether a specific time zone is matched with the recommended time zone when the specific time zone comes, and outputs the additional information on the screen according to whether to have the additional information corresponding to the time zone when the specific time zone is matched with the recommended time zone.

15-21. (canceled)

22. A method for providing an additional service using a screen lock mode, the method comprising:
collecting, by a service device, additional information associated with a wallet service;
transmitting, by the service device, the collected additional information to one or more terminals through a wallet application;
determining, by the service device, detailed information about the additional information requested through the wallet application according to cancellation of a screen lock function of the terminal; and
providing, by the service device, the determined detailed information to the corresponding terminal.

23. The method according to claim 22, wherein the transmitting includes matching, by the service device, the additional information collected from payment service companies and service providing companies with image information corresponding to the additional information to transmit the matched information to the one or more terminals in real time.

24. The method according to claim 22, wherein the determining includes determining, by the service device, the additional information including the detailed information of at least one of recommended card information, advertising information, discount information, and coupon information.

25. The method according to claim 22, wherein the providing further includes
setting, by the service device, a recommended time zone with respect to a specific terminal, and
transmitting, by the service device, at least one of recommended card information, advertising information, discount information, and coupon information to the corresponding terminal when the set time zone comes.

26. The method according to claim 22, after the providing, further comprising:
determining, by the service device, a frequency of use of a coupon or a discount card among membership services with respect to the one or more terminals;
extracting, by the service device, an item existing in the same category as the coupon or the discount card; and
transmitting, by the service device, the extracted item to the terminal.

27-50. (canceled)
